(19) United States
(12) Patent Application Publication
(10) Pub. No.: US 2019/0359028 A1
(43) Pub. Date: Nov. 28, 2019

(54) VEHICLE AIR CONDITIONING UNIT

(71) Applicant: DENSO CORPORATION, Kariya-city (JP)

(72) Inventors: Hiroki HASHIMOTO, Kariya-city (JP); Tomori HASEGAWA, Kariya-city (JP); Shinsuke KONISHI, Kariya-city (JP)

(21) Appl. No.: 16/535,892

(22) Filed: Aug. 8, 2019

Related U.S. Application Data
(63) Continuation of application No. PCT/JP2018/001434, filed on Jan. 18, 2018.

(30) Foreign Application Priority Data
Feb. 14, 2017 (JP) 2017-025281
Dec. 1, 2017 (JP) 2017-231987

(51) Int. Cl. B60H 1/00

(52) U.S. Cl. CPC B60H 1/00742; B60H 1/00871; B60H 1/00828

(57) ABSTRACT

A vehicle air conditioning unit is installed in a vehicle, and the vehicle includes a target seat placed in a vehicle compartment and having a seat back that can be reclined. The vehicle air conditioning unit includes an outlet portion having an outlet which is open in front of the target seat and through which air is blown toward the target seat in the vehicle compartment, and a blower that increases or decreases a blown air volume of the air blown out from the outlet. A controller of the vehicle air conditioning unit controls the blower to increase the blown air volume with reclination of the seat back causing a backrest surface of the seat back to face upward.

### CROSS REFERENCE TO RELATED APPLICATIONS

The present application is a continuation application of International Patent Application No. PCT/JP2018/001434 filed on Jan. 18, 2018, which designated the United States and claims the benefit of priority from Japanese Patent Application No. 2017-025281 filed on Feb. 14, 2017, and Japanese Patent Application No. 2017-231987 filed on Dec. 1, 2017.

### TECHNICAL FIELD

The present disclosure relates to a vehicle air conditioning unit.

### BACKGROUND

An air conditioner for a vehicle blows conditioned air from a plurality of outlets provided on an instrument panel in a vehicle compartment.

### SUMMARY

According to at least one embodiment of the present disclosure, a vehicle air conditioning unit is installed in a vehicle including a target seat placed in a vehicle compartment. The vehicle air conditioning unit includes an outlet portion having an outlet which is open in front of the target seat and through which air is blown toward the target seat in the vehicle compartment.

### BRIEF DESCRIPTION OF DRAWINGS

FIG. 1 is a schematic view schematically illustrating a main part of a vehicle air conditioning unit of at least one embodiment and the vicinity of a driver's seat in a vehicle compartment.

FIG. 2 is a block diagram illustrating a control system of the vehicle air conditioning unit of at least one embodiment.

FIG. 3 is an enlarged view of area III in FIG. 1, illustrating an attitude of an air direction adjustment fin by which the blowing direction of the blown air is set obliquely upward.

FIG. 4 is an enlarged view of area III in FIG. 1, illustrating an attitude of the air direction adjustment fin by which the blowing direction of the blown air is set obliquely downward.

FIG. 5 is a schematic view similar to FIG. 1, illustrating each of a seat angle and a seat position of a driver's seat, a blown air volume of the air blown into the vehicle compartment from an outlet, and a blowing direction of the air.

FIG. 6 is a first flowchart illustrating control processing executed by a control unit in the vehicle air conditioning unit of at least one embodiment.

FIG. 7 is a second flowchart illustrating control processing executed by the control unit in the vehicle air conditioning unit of at least one embodiment.

FIG. 8 is a graph illustrating an air direction map for determining a target air direction of the blown air using the seat position and seat angle of the driver's seat as parameters.

FIG. 9 is a graph illustrating an air volume map for determining a target air volume of the blown air using the seat position and seat angle of the driver's seat as parameters.

FIG. 10 is a schematic view illustrating a state in which a seat back of the driver's seat is reclined and the upper body of an occupant is inclined backward with respect to a driving posture, according to at least one embodiment.

FIG. 11 is a schematic view illustrating a state in which the seat position of the driver's seat is shifted to a rear side of the vehicle from the position where the occupant is in the driving posture, according to at least one embodiment.

FIG. 12 is a schematic view equivalent to FIG. 1, schematically illustrating a main part of a vehicle air conditioning unit of at least one embodiment and the vicinity of a driver's seat in a vehicle compartment.

FIG. 13 is a flowchart illustrating control processing executed by a control unit in the vehicle air conditioning unit of at least one embodiment.

FIG. 14 is a first view for explaining a comparative vehicle air conditioning unit, illustrating a relationship between an occupant who is a driver in the driving posture and blown air from a face outlet.

FIG. 15 is a second view for explaining the comparative vehicle air conditioning unit, illustrating a relationship between an occupant who is a driver seated in a reclined driver's seat and blown air from the face outlet.

### DETAILED DESCRIPTION

In a comparative vehicle air conditioning unit, a volume and direction of air blown out from outlets open into a vehicle compartment are set automatically or manually by an occupant.

However, seats installed in the vehicle compartment such as a driver's seat and a passenger seat can be adjusted in position in a front-rear direction, and at the same time, seat backs of the seats can be reclined. A change in the position of a seat in the front-rear direction also changes the position of an occupant seated in the seat, and the posture of the occupant seated in the seat changes when the seat back is reclined. Thus, the blown air from the outlets may not be properly blown on the occupant who is seated depending on the position of the seat in the front-rear direction or the reclining angle of the seat. The blown air may not be properly blown on the occupant. For example, the blown air may not be blown on the occupant well, the blown air is blown on the occupant too much, or the blown air is blown on an area of the occupant's body that is different from an area intended by the design.

When the blown air is not properly blown on the occupant as described above, the comfort of the occupant in terms of air conditioning in the vehicle compartment may be compromised. The above has been found as a result of detailed studies by the inventors.

In view of the above points, the present disclosure provides a vehicle air conditioning unit that can provide comfortable air conditioning appropriately to the posture of an occupant who is seated.

According to one aspect of the present disclosure, a vehicle air conditioning unit is installed in a vehicle including a target seat placed in a vehicle compartment. The target seat has a seat back operable to be reclined. The vehicle air conditioning unit includes an outlet portion having an outlet which is open in front of the target seat and through which air is blown toward the target seat in the vehicle compartment, an air volume adjustment device that increases or decreases a blown air volume of the air blown out from the outlet, and a control unit that controls the air volume adjustment device to increase the blown air volume with reclination of the seat back causing a backrest surface of the seat back to face upward.

As a result, when the posture of an occupant seated in the target seat changes, the occupant does not feel a change in air pressure of the blown air from the outlet. Therefore, comfortable air conditioning can be provided appropriately to the posture of the occupant.

According to another aspect of the present disclosure, a vehicle air conditioning unit is installed in a vehicle including a target seat placed in a vehicle compartment. The target seat has a seat back operable to be reclined. The vehicle air conditioning unit includes an outlet portion having an outlet which is open in front of the target seat and through which air is blown toward the target seat in the vehicle compartment, an air direction adjustment device that adjusts a blowing direction of the air blown out from the outlet angularly upward or downward, and a control unit that controls the air direction adjustment device to change the blowing direction downward with reclination of the seat back causing a backrest surface of the seat back to face upward.

As a result, when the posture of the occupant seated in the target seat changes, change of an area of the body of the occupant on which the blown air is blown from the outlet can be limited. Therefore, comfortable air conditioning can be provided appropriately to the posture of the occupant.

According to another aspect of the present disclosure, a vehicle air conditioning unit is installed in a vehicle including a target seat placed in a vehicle compartment. The target seat has a seat back operable to be reclined. The vehicle air conditioning unit includes a first outlet portion having a first outlet through which air is blown toward an upper body of an occupant seated in the target seat, a second outlet portion having a second outlet through which air is blown to a lower area in the vehicle compartment than the first outlet, an air volume ratio change unit that changes a first outlet air volume ratio which is a ratio of a blown air volume of the air blown out from the first outlet to a total air volume of the airs blown out from the first outlet and the second outlet, and a control unit. When a direction in which the seat back is reclined to cause a backrest surface of the seat back to face upward is defined as a direction that a reclination angle of the seat back is positive and increases, and the reclination angle is larger than or equal to a predetermined angle threshold in a blow mode in which the air is blown into the vehicle compartment from the first outlet and the second outlet, the control unit controls the air volume ratio change unit to set the first outlet air volume ratio to be larger than that when the reclination angle is smaller than the angle threshold.

As a result, when the seat back of the target seat in which the occupant is seated is reclined to allow the occupant to be in a lying posture, for example, an occupant's feeling of decrease in the volume of air blown on his upper body can be reduced. Therefore, comfortable air conditioning can be provided appropriately to the posture of the occupant.

Prior to describing embodiments, a comparative vehicle air conditioning unit will be described first. In the comparative vehicle air conditioning unit, the blown air volume and blowing direction of the air blown out from a face outlet 14a provided on an instrument panel 71 in a vehicle compartment are not linked to a position in a front-rear direction and a reclining angle of a driver's seat 74.

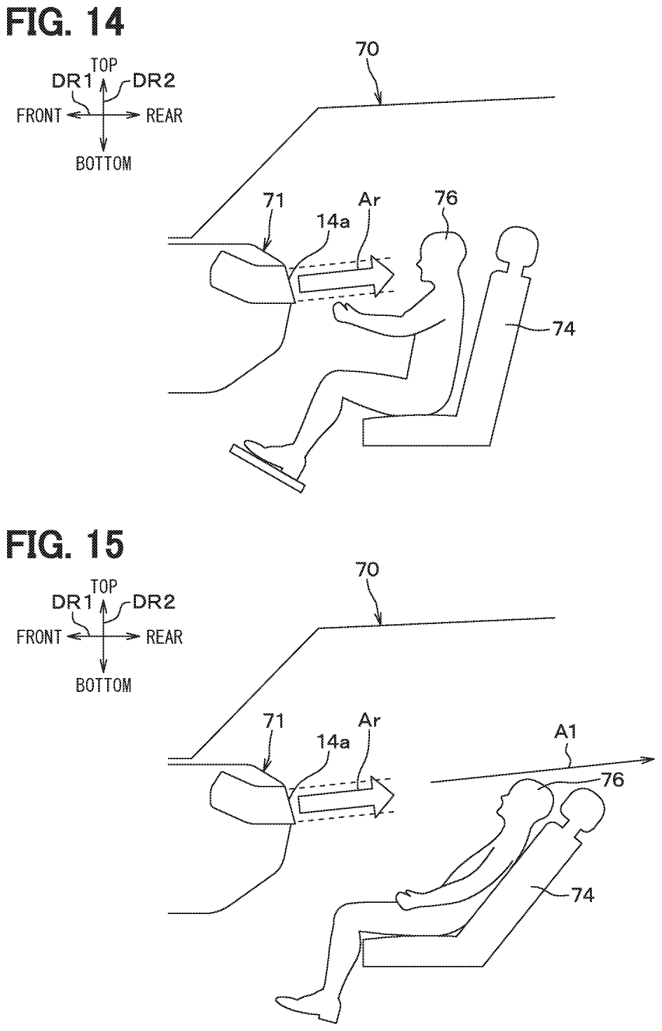

Specifically, there is assumed a case where an occupant 76 seated in the driver's seat 74 takes a driving posture for driving a vehicle. In that case, blown air Ar from the face outlet 14a that is properly blown on the occupant 76 as illustrated in FIG. 14 may not be properly blown on the occupant 76 when the posture of the occupant 76 changes from the driving posture. For example, when the driver's seat 74 is reclined as illustrated in FIG. 15, the blown air Ar goes over the head of the occupant 76 in a reclining posture and goes straight to a rear side of the vehicle as indicated by arrow A1, thereby not being properly blown on the occupant 76.

A vehicle air conditioning unit 10 of embodiments described below is configured in view of the above points.

Embodiments will now be described with reference to the drawings. In the following embodiments including other embodiments to be described later, parts that are identical or equivalent to each other are denoted by the same reference numerals in the drawings.

### First Embodiment

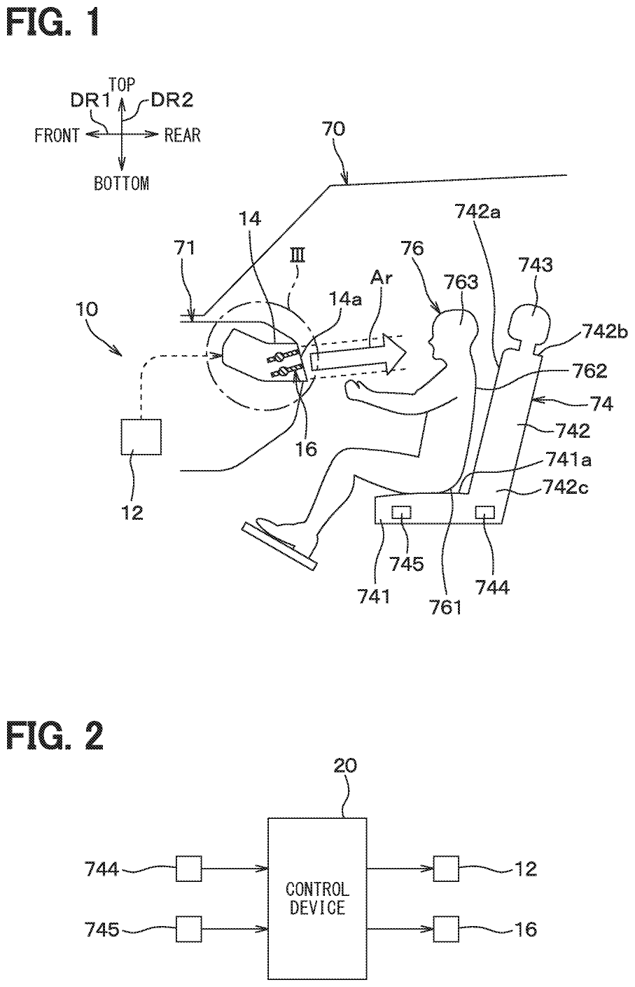

FIG. 1 is a schematic view schematically illustrating a main part of a vehicle air conditioning unit 10 of the present embodiment and the vicinity of a driver's seat 74 in a vehicle compartment. FIG. 1 is a view seen from a left side of a vehicle, where an instrument panel 71 and the interior thereof are illustrated in cross section.

The vehicle air conditioning unit 10 illustrated in FIG. 1 is a device for blowing temperature-controlled, conditioned air into the vehicle compartment. The vehicle air conditioning unit 10 is installed in a vehicle 70. The vehicle air conditioning unit 10 forms a vehicle air conditioner together with a compressor, a condenser, and the like disposed outside the vehicle compartment (such as in an engine compartment) and forming a refrigeration cycle.

As illustrated in FIG. 1, the vehicle air conditioning unit 10 is disposed on a front side of the vehicle in the vehicle compartment. Specifically, the vehicle air conditioning unit 10 is disposed in the instrument panel 71 provided at a front portion of the vehicle in the vehicle compartment. The instrument panel 71 is disposed on the front side of the vehicle with respect to a front seat provided in the vehicle compartment.

The front seat is a seat disposed on the foremost side of the vehicle among a plurality of seats arranged in a vehicle front-rear direction DR1 in the vehicle compartment of the vehicle 70 equipped with the vehicle air conditioning unit 10, and is a generic term for the driver's seat 74 and a passenger seat. The front seat is installed while facing the front side of the vehicle in the vehicle compartment. FIG. 1 illustrates the driver's seat 74 among the front seats.

Arrows DR1 and DR2 in FIG. 1 indicate the orientation of the vehicle 70 equipped with the vehicle air conditioning unit 10. That is, arrow DR1 indicates the vehicle front-rear direction DR1, and arrow DR2 indicates a vehicle top-bottom direction DR2.

As illustrated in FIGS. 1 and 2, the vehicle air conditioning unit 10 includes a blower 12, an outlet portion 14, an air direction adjustment device 16, and a control unit 20. The vehicle air conditioning unit 10 further includes a cooling heat exchanger which is an evaporator of the refrigeration cycle, for example, a heating heat exchanger which is a heater core for heating air with engine coolant, for example, an air conditioning case, and the like. The cooling heat exchanger, the heating heat exchanger, and the air conditioning case are not shown. For example, the air conditioning case internally forms an air passage through which air blown out from the blower 12 passes, and the cooling heat exchanger and the heating heat exchanger are disposed in the air passage.

In the vehicle air conditioning unit 10, the air from the blower 12 is temperature-controlled by the cooling heat exchanger and the heating heat exchanger, and is blown into the vehicle compartment as temperature-controlled, conditioned air from the outlet portion 14 as illustrated in FIG. 1. Specifically, the outlet portion 14 illustrated in FIG. 1 is a face outlet portion facing a front seat occupant. In addition to the outlet portion 14 in FIG. 1, the vehicle air conditioning unit 10 has a foot outlet portion and a defroster outlet portion, for example, and the conditioned air is in some cases blown out from the foot outlet portion or the defroster outlet portion.

The outlet portion 14 in FIG. 1 is provided as a part of the instrument panel 71, and an outlet 14a that is open rearward in the vehicle front-rear direction DR1 is formed in the outlet portion 14. That is, the outlet 14a is a face outlet that blows air toward the upper body of a front seat occupant seated in the front seat. The outlet 14a is thus open in front of the driver's seat 74 as a target seat which is one of the front seats of the vehicle 70, and blows air toward the driver's seat 74. For example, the outlet 14a blows air while facing roughly the rear side of the vehicle at a position higher than a seating surface 741a of the driver's seat 74. Arrow Ar in FIG. 1 represents blown air Ar that is blown into the vehicle compartment from the outlet 14a.

The driver's seat 74 is a seat in which an occupant 76, who is a driver among the front seat occupants, is seated. The driver's seat 74 is installed to be slidable in the vehicle compartment. Specifically, the driver's seat 74 can be slid in the vehicle front-rear direction DR1 and thus be slid toward or away from the outlet 14a provided on the instrument panel 71.

The driver's seat 74 also has a seat cushion 741, a seat back 742, and a headrest 743. The seat cushion 741 is a seat portion on which the seating surface 741a to be in contact with buttocks 761 of the occupant 76 is formed. That is, the seat cushion 741 supports the occupant 76 from the lower side of the occupant 76.

The seat back 742 is a backrest portion on which a backrest surface 742a is formed. The backrest surface 742a faces a back 762 of the occupant 76, and the back 762 comes into contact with the backrest surface 742a. That is, the seat back 742 supports the occupant 76 from the side of the back 762 of the occupant 76.

The headrest 743 supports a head 763 of the occupant 76 from the rear side of the vehicle, and is connected to an upper end 742b of the seat back 742.

FIG. 1 illustrates a state in which the occupant 76 is in the driving posture. As illustrated in FIG. 1, when the occupant 76 is in the driving posture, the backrest surface 742a in contact with the back 762 of the occupant 76 faces roughly the front side of the vehicle.

The seat back 742 is connected to a rear end of the seat cushion 741 at a lower end 742c of the seat back 742, and turns at the lower end 742c about an axis extending in a vehicle left-right direction (that is, a vehicle width direction). The seat back 742 can be reclined by turning about the axis extending in the vehicle left-right direction. For example, the seat back 742 is reclined such that the backrest surface 742a faces the upper side of the vehicle as the headrest 743 provided at the upper end 742b of the seat back 742 is positioned on the rear side of the vehicle.

The blower 12 of the vehicle air conditioning unit 10 has a motor and a fan (not shown). The fan is connected to the motor and is rotated by the motor. For example, the speed of the motor, that is, the speed of the fan, of the blower 12 increases as a blower motor voltage applied to the motor increases. The air sent from the blower 12 is eventually blown into the vehicle compartment through the outlet 14a. Therefore, the blower 12 functions as an air volume adjustment device that increases or decreases a blown air volume V of the air Ar blown out from the outlet 14a. The blown air volume V increases as the blower motor voltage increases. The blown air volume V is a volumetric flow rate of air, for example, and is in the unit of “m3/h”, for example.

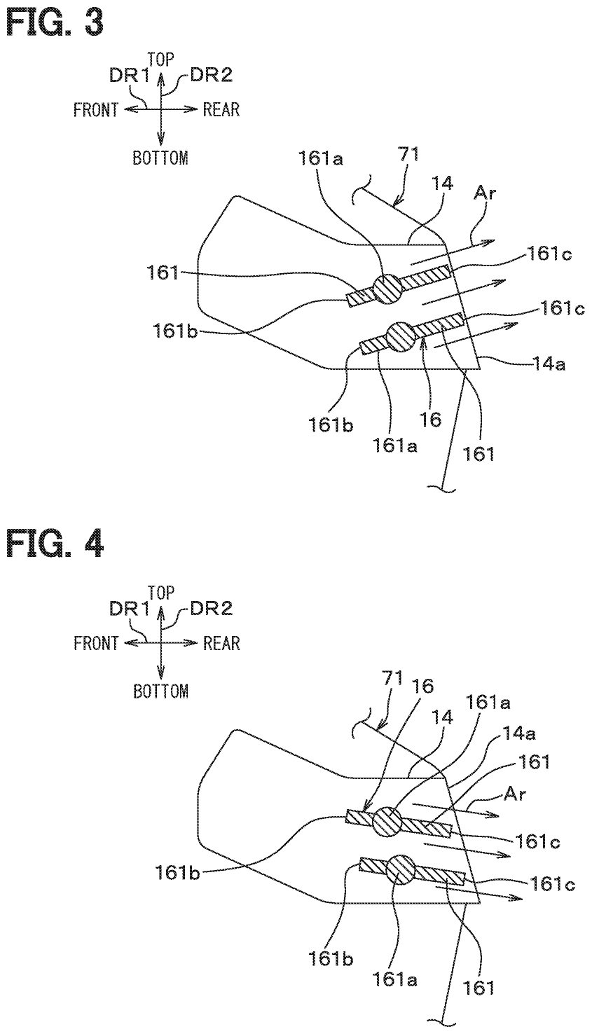

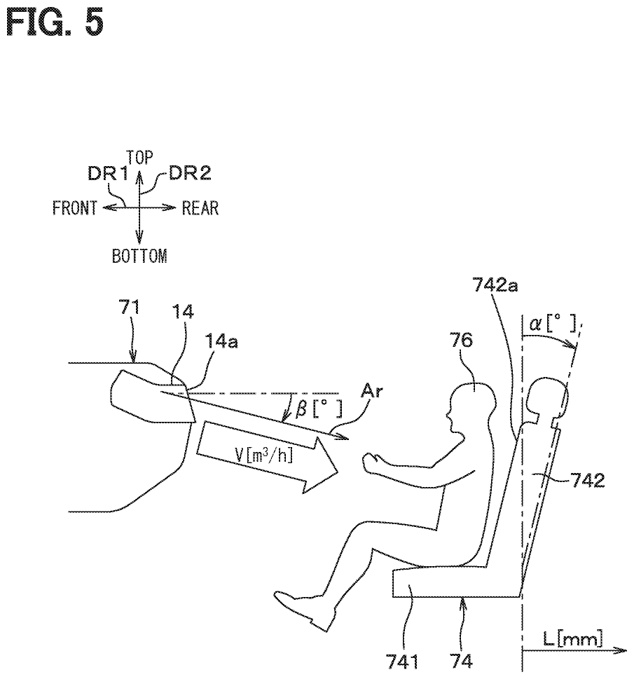

As illustrated in FIGS. 1 and 3, the air direction adjustment device 16 adjusts the angle of a direction β (that is, a blowing direction β) of the blown air Ar blown out from the outlet 14a up and down. To that end, the air direction adjustment device 16 has an air direction adjustment actuator (not shown) and a plurality of air direction adjustment fins 161 connected to the air direction adjustment actuator. The air direction adjustment actuator turns each of the plurality of air direction adjustment fins 161 in accordance with a control signal from the control unit 20. The blowing direction β is indicated in FIG. 5 to be described later.

The air direction adjustment fins 161 are each formed in the shape of a flat plate extending in the vehicle width direction and can each turn about a turning shaft 161a extending in the vehicle width direction. The air direction adjustment fins 161 are disposed in the outlet 14a. Thus, the blown air Ar blown out from the outlet 14a is guided along the air direction adjustment fins 161 having the shape of the flat plates. That is, adjusting the angle of the blowing direction β of the blown air Ar up and down is to adjust the angles of the air direction adjustment fins 161 about the turning shafts 161a. The plurality of air direction adjustment fins 161 are connected to one another via a link mechanism, for example, and turn while maintaining the attitude parallel to one another.

The air direction adjustment fins 161 each have a front end 161b in the vehicle front-rear direction DR1 as an upstream end 161b of the air flow through the outlet 14a. Moreover, the air direction adjustment fins 161 each have a rear end 161c in the vehicle front-rear direction DR1 as a downstream end 161c of the air flow through the outlet 14a.

For example, as illustrated in FIG. 3, the blowing direction β of the blown air Ar is set obliquely upward when the air direction adjustment fins 161 are inclined such that the upstream ends 161b are positioned on the lower side of the vehicle relative to the downstream ends 161c. Conversely, as illustrated in FIG. 4, the blowing direction β of the blown air Ar is set obliquely downward when the air direction adjustment fins 161 are inclined such that the upstream ends 161b are positioned on the upper side of the vehicle relative to the downstream ends 161c.

The control unit 20 illustrated in FIG. 2 is an electronic control device configured by a microcomputer including a CPU, a ROM, a RAM, and the like (not shown). A signal from a sensor or the like connected to the control unit 20 is input to the microcomputer after being A/D converted by an input circuit (not shown). Semiconductor memories such as the ROM and the RAM are non-transitory tangible storage media.

In the present embodiment, for example, the control unit 20 adjusts the blower motor voltage as a control signal of the blower 12 as illustrated in FIGS. 1 and 2. The control unit 20 also outputs a control signal for bringing the air direction adjustment actuator into operation to the air direction adjustment actuator of the air direction adjustment device 16.

In the present embodiment, the driver's seat 74 includes a seat angle sensor 744 for detecting the seat angle α which is a reclination angle α of the seat back 742, and a seat position sensor 745 for detecting the seat position L of the driver's seat 74 in the vehicle front-rear direction DR1. The seat angle sensor 744 sequentially outputs a detection signal indicating the seat angle α to the control unit 20, and the seat position sensor 745 sequentially outputs a detection signal indicating the seat position L to the control unit 20. The unit of the seat angle α is “°”, for example, and the unit of the seat position L is “mm”, for example.

In the present embodiment, as illustrated in FIG. 5, the seat angle α of the driver's seat 74 is represented by a difference in angle with respect to a predetermined reference angular position of the seat back 742, for example. The positive direction of the seat angle α corresponds to the direction in which the seat back 742 is reclined to cause the backrest surface 742a to face upward. In short, the positive direction of the seat angle α corresponds to the direction in which the seat back 742 is reclined. The reference angular position of the seat back 742 is, for example, an angular position at which the backrest surface 742a faces the front of the vehicle. Therefore, in the present embodiment, the seat angle α has a larger value as the seat back 742 is reclined to cause the backrest surface 742a of the seat back 742 to face upward. The seat angle α may be referred to as a reclining angle α of the driver's seat 74.

In the present embodiment, the seat position L of the driver's seat 74 is represented by, for example, a distance in the vehicle front-rear direction DR1 with respect to a predetermined reference position of the driver's seat 74. The positive direction of the seat position L is the direction corresponding to the rear of the vehicle. Therefore, in the present embodiment, the seat position L has a larger value as the driver's seat 74 slides toward the rear side of the vehicle.

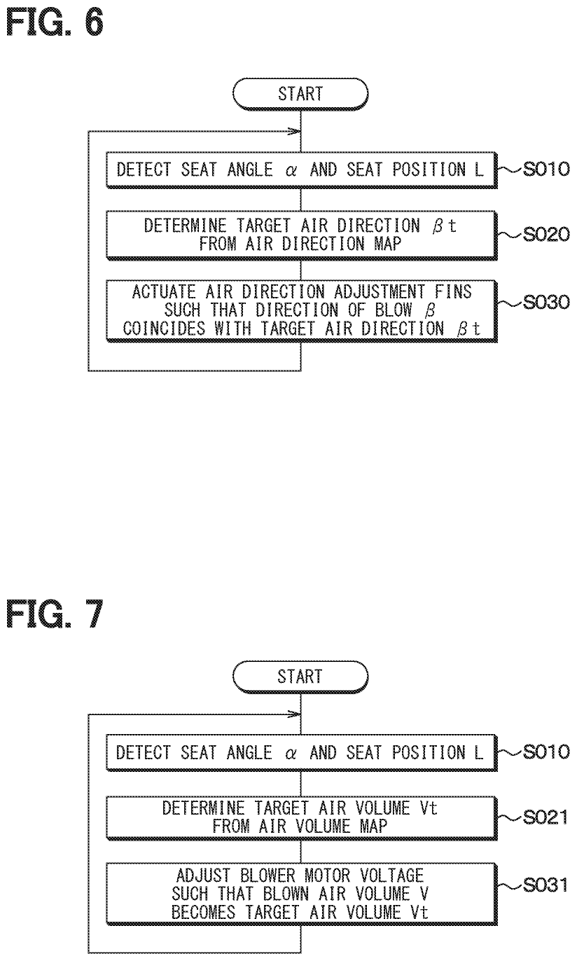

The control unit 20 functions as an air conditioning control device that executes various kinds of air-conditioning control in the vehicle air conditioning unit 10, and executes control processing illustrated in FIGS. 6 and 7 as one of the air-conditioning control.

FIG. 6 is a first flowchart illustrating the control processing executed by the control unit 20. FIG. 7 is a second flowchart illustrating the control processing executed by the control unit 20. The control unit 20 starts each of the control processing of FIG. 6 and the control processing of FIG. 7 when the vehicle air conditioning unit 10 is operated in a blow mode in which the air is blown out from the outlet 14a of FIG. 1. The blow mode in which the air is blown out from the outlet 14a of FIG. 1 may be a mode in which the air is blown out only from the outlet 14a of FIG. 1 or a mode in which the air is blown out from an outlet other than the outlet 14a at the same time the air is blown out from the outlet 14a of FIG. 1.

When the vehicle air conditioning unit 10 is stopped or when the blow mode in which the air is blown out from the outlet 14a is released, the control unit 20 ends the control processing of FIG. 6 and the control processing of FIG. 7. The control unit 20 executes the control processing of FIG. 6 and the control processing of FIG. 7 in parallel.

First, the control processing of FIG. 6 will be described. As illustrated in FIG. 6, in step S010, the control unit 20 acquires the seat angle α of the driver's seat 74 detected by the seat angle sensor 744 from the seat angle sensor 744. At the same time, the control unit 20 acquires the seat position L of the driver's seat 74 detected by the seat position sensor 745 from the seat position sensor 745. As a result, the posture of the occupant 76 seated in the driver's seat 74 can be determined. After step S010, the processing proceeds to step S020.

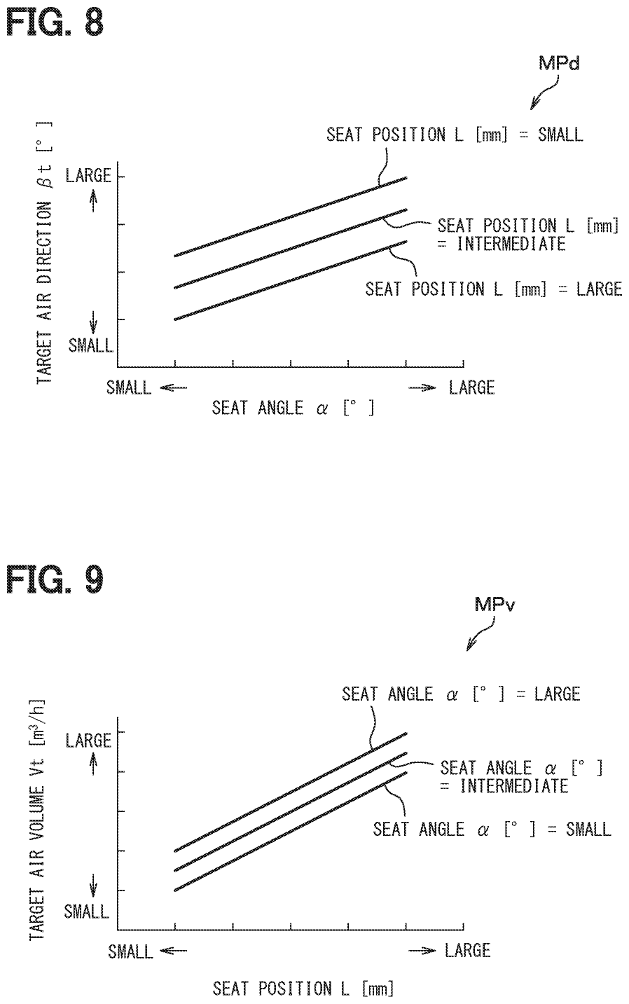

In step S020, the control unit 20 determines a target air direction βt from an air direction map MPd illustrated in FIG. 8 on the basis of the seat angle α and the seat position L of the driver's seat 74. The air direction map MPd is a map in which the relationship among the seat angle α, the seat position L, and the target air direction βt are experimentally determined in advance. The target air direction βt is a target direction of the blowing direction β of the air Ar blown into the vehicle compartment from the outlet 14a. In the present embodiment, for example, the blowing direction β is expressed as an angle of blow formed with respect to a predetermined reference direction, as illustrated in FIG. 5. That is, the unit of the blowing direction β is “°” in the present embodiment. The reference direction of the blowing direction β is, for example, horizontal and directed to the rear of the vehicle. The positive direction of the blowing direction β as the angle of blow is directed downward with respect to the reference direction. Likewise, the target air direction βt is expressed as a target angle of blow.

Accordingly, an increase in the blowing direction β as the angle of blow is to bring the blowing direction β closer to a downward direction (a vertically downward direction, to be exact). Conversely, a decrease in the blowing direction β as the angle of blow is to bring the blowing direction β closer to an upward direction (a vertically upward direction, to be exact).

The blown air Ar blown into the vehicle compartment from the outlet 14a flows along the air direction adjustment fins 161 having the shape of the flat plates, whereby the blowing direction β may be expressed as the attitude or angle (such as the angle of inclination with respect to the horizontal) of the air direction adjustment fins 161. After step S020 in FIG. 6, the processing proceeds to step S030.

In step S030, the control unit 20 outputs a control signal to the air direction adjustment actuator, thereby causing the air direction adjustment fins 161 of the air direction adjustment device 16 to be actuated such that the blowing direction β of the blown air Ar coincides with the target air direction βt. When the blowing direction β already coincides with the target air direction βt, the control unit 20 maintains the attitude of the air direction adjustment fins 161 as is. After step S030, the processing returns to step S010.

As in the control processing of FIG. 6, the blowing direction β of the blown air Ar is adjusted to coincide with the target air direction βt determined from the air direction map MPd of FIG. 8. In the relationship between the target air direction βt and the seat position L of the driver's seat 74 in the air direction map MPd, as illustrated in FIGS. 5 and 8, the target air direction βt has a larger value as the seat position L has a smaller value. In other words, the target air direction βt approaches the downward direction as the driver's seat 74 moves toward the front of the vehicle. The control unit 20 thus controls the air direction adjustment device 16 such that the blowing direction β of the blown air Ar approaches the downward direction as the driver's seat 74 approaches the outlet 14a.

In the relationship between the target air direction βt and the seat angle α of the driver's seat 74 in the air direction map MPd, the target air direction βt has a larger value as the seat angle α has a larger value. In other words, the target air direction βt approaches the downward direction as the seat back 742 is reclined to cause the backrest surface 742a of the seat back 742 to face upward. The control unit 20 thus controls the air direction adjustment device 16 such that the blowing direction β of the blown air Ar approaches the downward direction as the seat back 742 is reclined to cause the backrest surface 742a of the seat back 742 to face upward.

Next, the control processing of FIG. 7 will be described. As illustrated in FIG. 7, step S010 of the control processing of FIG. 7 is the same as step S010 of the control processing of FIG. 6 described above. After step S010 of FIG. 7, the processing proceeds to step S021.

In step S021, the control unit 20 determines a target air volume Vt from an air volume map MPv illustrated in FIG. 9 on the basis of the seat angle α and the seat position L of the driver's seat 74. The air volume map MPv is a map in which the relationship among the seat angle α, the seat position L, and the target air volume Vt are experimentally determined in advance. The target air volume Vt is a target value of the blown air volume V of the air Ar blown into the vehicle compartment from the outlet 14a. After step S021 of FIG. 7, the processing proceeds to step S031.

In step S031, the control unit 20 adjusts the blower motor voltage applied to the motor of the blower 12 such that the blown air volume V of the blown air Ar becomes the target air volume Vt. Specifically, the control unit 20 determines a target voltage which is a target value of the blower motor voltage at which the blown air volume V becomes the target air volume Vt, and sets the blower motor voltage to the target voltage. The control unit 20 maintains the blower motor voltage as is when the blown air volume V is already equal to the target air volume Vt, specifically, when the blower motor voltage is already equal to the target voltage. After step S031, the processing returns to step S010.

As in the control processing of FIG. 7, the blown air volume V of the blown air Ar is adjusted to equal the target air volume Vt determined from the air volume map MPv of FIG. 9. In the relationship between the target air volume Vt and the seat position L of the driver's seat 74 in the air volume map MPv, as illustrated in FIGS. 5 and 9, the target air volume Vt has a larger value as the seat position L has a larger value. In other words, the target air volume Vt increases as the driver's seat 74 moves toward the rear of the vehicle. The control unit 20 thus controls the blower 12 such that the blown air volume V of the blown air Ar increases as the driver's seat 74 moves away from the outlet 14a.

In the relationship between the target air volume Vt and the seat angle α of the driver's seat 74 in the air volume map MPv, the target air volume Vt has a larger value as the seat angle α has a larger value. In other words, the target air volume Vt increases as the seat back 742 is reclined to cause the backrest surface 742a of the seat back 742 to face upward. The control unit 20 thus controls the blower 12 such that the blown air volume V of the blown air Ar increases as the seat back 742 is reclined to cause the backrest surface 742a of the seat back 742 to face upward.

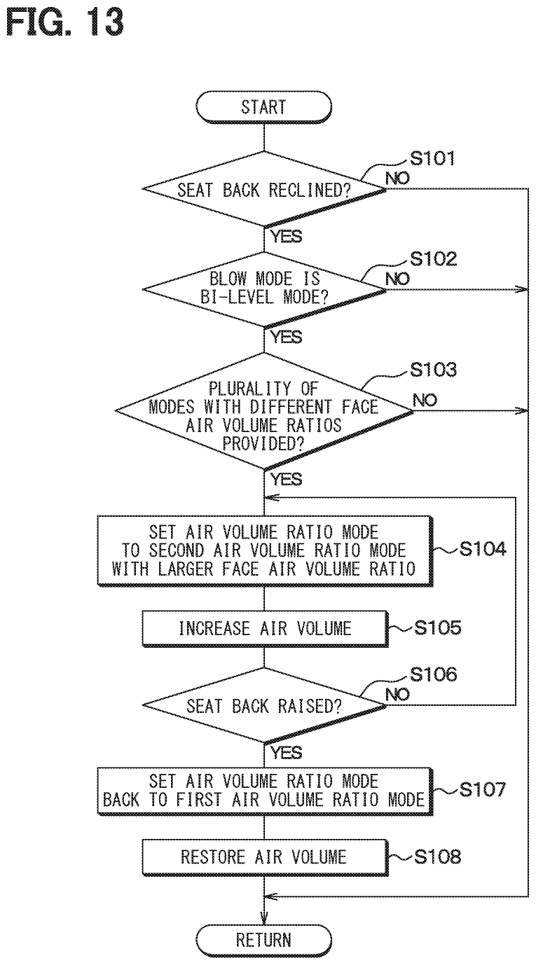

The processing in each step of FIGS. 6 and 7 described above configures a functional unit for implementing each function. The similar applies to a flowchart of FIG. 13 described later.

As described above, according to the present embodiment, the control unit 20 controls the blower 12 as illustrated in FIGS. 7 and 9. That is, the control unit 20 controls the blower 12 such that the blown air volume V increases as the driver's seat 74 moves away from the outlet 14a and as the seat back 742 is reclined to cause the backrest surface 742a of the seat back 742 to face upward.

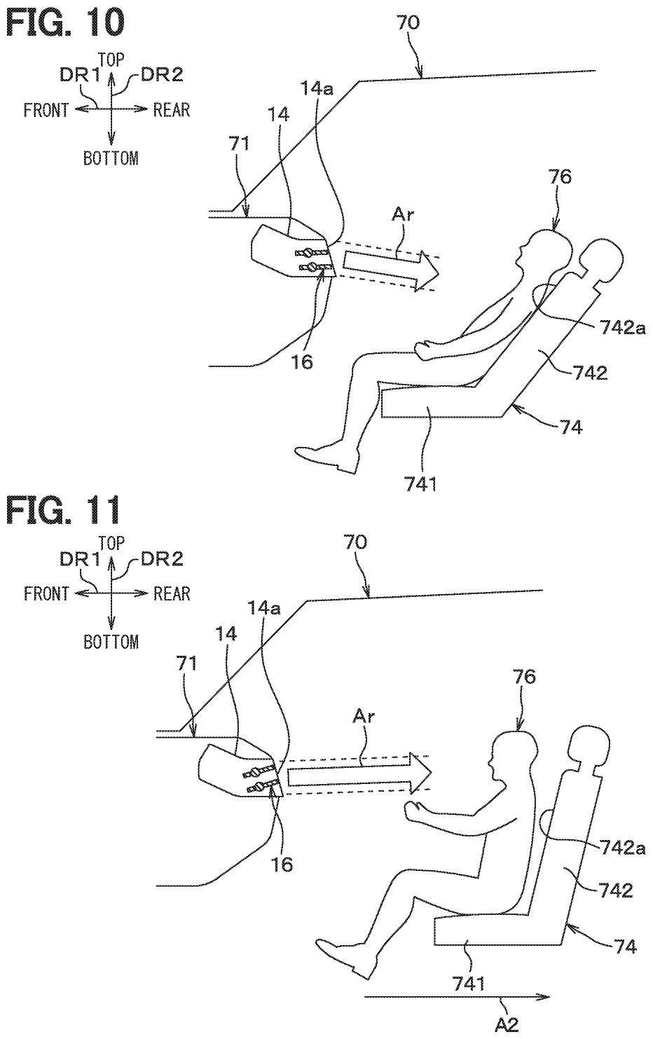

For example, as illustrated in FIG. 10, when the seat back 742 is reclined to allow the occupant 76 to be in the reclining posture in which the upper body of the occupant 76 is inclined backward relative to the driving posture, the blown air volume V increases depending on the seat angle α of the driver's seat 74. Moreover, as indicated by arrow A2 in FIG. 11, when the seat position L of the driver's seat 74 moves to the rear side of the vehicle from the position where the occupant 76 is in the driving posture, the blown air volume V increases depending on the seat position L.

Such a change in the blown air volume V can prevent a case where the occupant 76 feels a change in air pressure of the blown air Ar from the outlet 14a when the position and posture of the occupant 76 seated in the driver's seat 74 change. Therefore, comfortable air conditioning can be provided appropriately to the position and posture of the occupant 76.

In the present embodiment, the blown air volume V is determined on the basis of the seat angle α and the seat position L, but can be determined on the basis of the seat angle α without using the seat position L. This is because, as described above with reference to FIG. 10, the increase and decrease in the blown air volume V can be explained in relation to the seat angle α.

Even in the case where the blown air volume V is determined on the basis of the seat angle α irrespective of the seat position L, there can be prevented the case where the occupant 76 feels a change in air pressure of the blown air Ar from the outlet 14a when the posture of the occupant 76 seated in the driver's seat 74 changes. Therefore, comfortable air conditioning can be provided appropriately to the posture of the occupant 76.

According to the present embodiment, the control unit 20 controls the air direction adjustment device 16 as illustrated in FIGS. 6 and 8. That is, the control unit 20 controls the air direction adjustment device 16 such that the blowing direction β of the blown air Ar approaches the downward direction as the driver's seat 74 approaches the outlet 14a and as the seat back 742 is reclined to cause the backrest surface 742a of the seat back 742 to face upward.

For example, as illustrated in FIG. 10, when the seat back 742 is reclined to allow the upper body of the occupant 76 to be inclined backward relative to the driving posture, the blowing direction β of the blown air Ar approaches the downward direction depending on the seat angle α of the driver's seat 74. Moreover, as indicated by arrow A2 in FIG. 11, when the seat position L of the driver's seat 74 moves to the rear side of the vehicle from the position where the occupant 76 is in the driving posture, the blowing direction β approaches the upward direction depending on the seat position L.

Such a change in the blowing direction β can prevent a case where the blown air Ar from the outlet 14a is blown on a different area of the body of the occupant 76 when the position and posture of the occupant 76 seated in the driver's seat 74 change. Therefore, comfortable air conditioning can be provided appropriately to the position and posture of the occupant 76.

In the present embodiment, the blowing direction β is determined on the basis of the seat angle α and the seat position L, but can be determined on the basis of the seat angle α without using the seat position L. This is because, as described above with reference to FIG. 10, a change in the blowing direction β can be explained in relation to the seat angle α.

Even in the case where the blowing direction β is determined on the basis of the seat angle α irrespective of the seat position L, there can be prevented the case where the blown air Ar from the outlet 14a is blown on a different area of the body of the occupant 76 when the posture of the occupant 76 seated in the driver's seat 74 changes. Therefore, comfortable air conditioning can be provided appropriately to the posture of the occupant 76.

### Second Embodiment

Next, a second embodiment will be described. In the present embodiment, points that are different from the first embodiment described above will mainly be described. The description of parts that are identical or equivalent to those of the aforementioned embodiment will be omitted or simplified. The similar applies to the description of an embodiment described later.

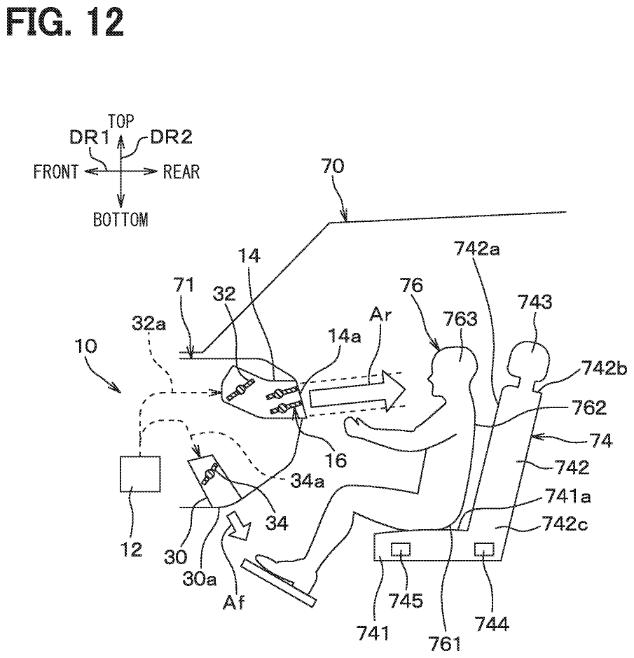

As illustrated in FIG. 12, a vehicle air conditioning unit 10 of the present embodiment includes a plurality of outlet portions for blowing air into the vehicle compartment. The plurality of outlet portions includes a face outlet portion 14 as a first outlet portion and a foot outlet portion 30 as a second outlet portion. The face outlet portion 14 is the same as the outlet portion 14 of the first embodiment. In the present embodiment, an outlet 14a is referred to as a face outlet 14a.

The vehicle air conditioning unit 10 of the present embodiment further includes a face door 32 and a foot door 34. The vehicle air conditioning unit 10 of the present embodiment includes a blower 12, an air direction adjustment device 16, a control unit 20, a cooling heat exchanger, a heating heat exchanger, an air conditioning case, and the like as with the first embodiment.

The foot outlet portion 30 is similar to the face outlet portion 14 in that the conditioned air is blown into the vehicle compartment, but is provided below the face outlet portion 14. A foot outlet 30a open into the vehicle compartment is formed on the foot outlet portion 30.

The face outlet 14a is an outlet for blowing air toward the upper body of an occupant 76 seated in a driver's seat 74 as a target seat, and is provided as a first outlet. The foot outlet 30a is an outlet for blowing air toward the lower body of the occupant 76 (specifically, the feet of the occupant 76) seated in the driver's seat 74 as indicated by arrow Af, and is provided as a second outlet. The foot outlet 30a thus blows air to the lower side in the vehicle compartment with respect to the face outlet 14a.

The blower 12 sends air to the face outlet 14a and the foot outlet 30a since not only the face outlet 14a but also the foot outlet 30a is provided. Specifically, the air sent from the blower 12 is temperature-controlled and then blown into the vehicle compartment from the outlet that is open among the plurality of outlets including the face outlet 14a and the foot outlet 30a.

The face door 32 opens and closes an air passage 32a for guiding the air from the blower 12 to the face outlet 14a. Specifically, the face door 32 can continuously change the opening of the air passage 32a, that is, the face opening, between a fully closed state and a fully open state of the air passage 32a. The face door 32 is operated on the basis of a control signal from the control unit 20.

The face door 32 changes the face opening to change the blown air volume V of the air Ar blown out from the face outlet 14a. For example, the blown air volume V from the face outlet 14a increases as the face opening is increased. When the face opening equals zero, the air passage 32a for guiding the air to the face outlet 14a is in the fully closed state so that the blown air volume V from the face outlet 14a equals zero.

The foot door 34 opens and closes an air passage 34a for guiding the air from the blower 12 to the foot outlet 30a. Specifically, the foot door 34 can continuously change the opening of the air passage 34a, that is, the foot opening, between a fully closed state and a fully open state of the air passage 34a. The foot door 34 is operated on the basis of a control signal from the control unit 20.

The foot door 34 changes the foot opening to change the blown air volume of the air blown out from the foot outlet 30a. For example, the blown air volume from the foot outlet 30a increases as the foot opening is increased. When the foot opening equals zero, the air passage 34a for guiding the air to the foot outlet 30a is in the fully closed state so that the blown air volume from the foot outlet 30a equals zero.

The increase and decrease in the blown air volume as described above allow the face door 32 and the foot door 34 to change a face air volume ratio (that is, a first outlet air volume ratio) described later through the operation of both of the face and foot doors 32, 34. In other words, the face door 32 and the foot door 34 form an air volume ratio change unit that changes the face air volume ratio. The face air volume ratio is a ratio of the blown air volume V from the face outlet 14a to a total air volume which is a sum of the blown air volume V from the face outlet 14a and the blown air volume from the foot outlet 30a.

The control unit 20 of the present embodiment illustrated in FIG. 2 switches a blow mode of the vehicle air conditioning unit 10 as one of various kinds of air-conditioning control executed by the control unit 20 according to a control program stored in the ROM or the like. Examples of the blow mode include a face mode, a foot mode, and a bi-level mode. The blow mode is switched by opening and closing of opening and closing doors provided in the air passages to the outlets such as the face door 32 and the foot door 34.

The face mode is the blow mode in which the conditioned air sent by the blower 12 is blown out exclusively from the face outlet 14a. The foot mode is the blow mode in which the conditioned air sent by the blower 12 is blown out exclusively from the foot outlet 30a. The bi-level mode is the blow mode in which the conditioned air sent by the blower 12 is blown out from both the face outlet 14a and the foot outlet 30a.

The bi-level mode of the present embodiment includes two air volume ratio modes having different face air volume ratios. The two air volume ratio modes are a first air volume ratio mode and a second air volume ratio mode in which the face air volume ratio is larger than that of the first air volume ratio mode. For example, in switching from the first air volume ratio mode to the second air volume ratio mode, the control unit 20 increases the face air volume ratio by causing the face door 32 to increase the face opening while causing the foot door 34 to maintain the foot opening.

The control unit 20 also executes control processing illustrated in FIG. 13 as one of the various kinds of air-conditioning control. FIG. 13 is a flowchart illustrating the control processing executed by the control unit 20 in the present embodiment. When the vehicle air conditioning unit 10 is put into operation, the control unit 20 starts the control processing of FIG. 13 and periodically and repeatedly executes the control processing of FIG. 13.

When the vehicle air conditioning unit 10 is stopped, the control unit 20 ends the control processing of FIG. 13. In the present embodiment, the control unit 20 executes the control processing of FIG. 13 in parallel with the control processing of FIG. 6 and the control processing of FIG. 7 described above.

As illustrated in FIG. 13, in step S101, the control unit 20 acquires the seat angle α of the driver's seat 74, that is, the reclination angle α of the seat back 742, detected by the seat angle sensor 744 (see FIG. 12), from the seat angle sensor 744. The seat angle α is illustrated in FIG. 5, and the positive direction of the seat angle α in the present embodiment corresponds to the direction in which the seat back 742 is reclined to cause the backrest surface 742a to face upward, as with the first embodiment.

The control unit 20 then determines whether or not the seat angle α is larger than or equal to a predetermined angle threshold α1. The control unit 20 basically determines whether or not the seat back 742 of the driver's seat 74 is reclined more than or equal to a predetermined limit in the reclining direction. The angle threshold α1 is experimentally determined in advance to be able to determine that the occupant 76 seated in the driver's seat 74 is in a lying posture.

The processing proceeds to step S102 if the seat angle α is determined to be larger than or equal to the angle threshold α1 in step S101. On the other hand, the processing of the present flowchart is ended if the seat angle α is determined to be smaller than the angle threshold α1, and the processing is started again from step S101.

In step S102, the control unit 20 determines whether or not the blow mode of the vehicle air conditioning unit 10 is the bi-level mode.

The processing proceeds to step S103 if the blow mode of the vehicle air conditioning unit 10 is determined to be the bi-level mode in step S102. On the other hand, the processing of the present flowchart is ended if the blow mode of the vehicle air conditioning unit 10 is determined to not be the bi-level mode, and the processing is started again from step S101. The blow mode of the vehicle air conditioning unit 10 is determined to not be the bi-level mode when the blow mode of the vehicle air conditioning unit 10 is the face mode or the foot mode, for example.

In step S103, the control unit 20 determines whether or not a plurality of air volume ratio modes with different face air volume ratios is provided in the bi-level mode. The processing proceeds to step S104 if it is determined that the plurality of air volume ratio modes is provided. On the other hand, the processing of the present flowchart is ended if it is determined that the plurality of air volume ratio modes is not provided, and the processing is started again from step S101.

In the present embodiment, the control unit 20 determines that the plurality of air volume ratio modes with different face air volume ratios is provided since the first air volume ratio mode and the second air volume ratio mode that can be switched in the bi-level mode are provided. Accordingly, the processing of the present flowchart proceeds from step S103 to step S104.

In step S104, the control unit 20 switches the air volume ratio mode in the bi-level mode from the first air volume ratio mode to the second air volume ratio mode. The face air volume ratio is increased as a result. If the air volume ratio mode is already set to the second air volume ratio mode, the control unit 20 maintains the second air volume ratio mode. Here, the face air volume ratio in the bi-level mode basically follows the first air volume ratio mode which is a basic mode. That is, the air volume ratio mode in the bi-level mode is the first air volume ratio mode unless switched from the first air volume ratio mode to the second air volume ratio mode in step S104.

The control unit 20 thus increases the face air volume ratio in step S104 after going through the determinations in steps S101 and S102. That is, in the bi-level mode, when the seat angle α becomes larger than or equal to the angle threshold α1, the control unit 20 controls the face door 32 and the foot door 34 such that the face air volume ratio becomes larger than when the seat angle α is smaller than the angle threshold α1. After step S104, the processing proceeds to step S105.

In step S105, the control unit 20 increases the total air volume of the air blown out from the face outlet 14a and the foot outlet 30a as compared to the case where the air volume ratio mode in the bi-level mode is set to the first air volume ratio mode. In other words, the control unit 20 controls the blower 12 such that the total air volume (that is, the volume of air sent by the blower 12) becomes larger than when the air volume ratio mode in the bi-level mode is set to the first air volume ratio mode.

The control processing of FIG. 13 is executed in parallel with the control processing of FIG. 7, so that the total air volume is increased by, for example, adding a predetermined air volume to the volume of air sent by the blower 12 as determined in step S031 of FIG. 7 and then driving the blower 12. The addition of the predetermined air volume to the volume of air sent by the blower 12 is canceled when the blow mode of the vehicle air conditioning unit 10 is switched from the bi-level mode to another blow mode.

Step S105 is thus performed together with step S104. That is, in the bi-level mode, when the seat angle α becomes larger than or equal to the angle threshold α1, the control unit 20 controls the blower 12 such that the volume of air sent by the blower 12 becomes larger than when the seat angle α is smaller than the angle threshold α1. After step S105, the processing proceeds to step S106.

In step S106 of FIG. 13, the control unit 20 acquires the seat angle α of the driver's seat 74 from the seat angle sensor 744 as in step S101. The control unit 20 then determines whether or not the seat angle α is smaller than the predetermined angle threshold α1. The control unit 20 basically determines whether or not the seat back 742 of the driver's seat 74 is raised.

The processing proceeds to step S107 if the seat angle α is determined to be smaller than the angle threshold α1 in step S106. On the other hand, the processing returns to step S104 if the seat angle α is determined to be larger than or equal to the angle threshold α1. That is, steps S104 and S105 are continuously executed during a period in which the seat angle α is larger than or equal to the angle threshold α1. However, the processing of the present flowchart is ended when the blow mode of the vehicle air conditioning unit 10 is switched to another mode other than the bi-level mode.

In step S107, the control unit 20 controls the face door 32 and the foot door 34 to set the air volume ratio mode in the bi-level mode back to the first air volume ratio mode from the second air volume ratio mode. As a result, the face air volume ratio becomes smaller than that in the second air volume ratio mode. That is, the face air volume ratio is restored to the value before being increased in step S104. After step S107, the processing proceeds to step S108.

In step S108, the control unit 20 controls the blower 12 to set the volume of air sent by the blower 12 back to the original volume which is the air volume before the increase in step S105. For example, the addition of the predetermined air volume to the volume of air sent by the blower 12 as executed in step S105 is canceled. The processing of the present flowchart is ended after completion of step S108, and the processing is started again from step S101.

Except as described above, the present embodiment is similar to the first embodiment. The present embodiment can obtain effects similar to those of the first embodiment from the configuration common to that of the first embodiment.

According to the present embodiment, when the seat angle α (see FIG. 5) is larger than or equal to the angle threshold α1 in the bi-level mode, the control unit 20 controls the doors 32 and 34 such that the face air volume ratio is larger than when the seat angle α is smaller than the angle threshold α1. When the face air volume ratio is increased by such control, the blown air volume V from the face outlet 14a is increased without increasing the volume of air sent by the blower 12. As a result, when the seat back 742 of the driver's seat 74 in which the occupant 76 is seated is reclined to allow the occupant 76 to be in the lying posture, for example, a feeling of decrease in the volume of air blown on the upper body by the occupant 76 can be reduced. Therefore, comfortable air conditioning can be provided appropriately to the posture of the occupant 76.

The balance of the volume of air felt by the occupant 76 between the upper body and the lower body can also be maintained in response to a change in the posture of the occupant 76.

According to the present embodiment, when the seat angle α is larger than or equal to the angle threshold α1 in the bi-level mode, the control unit 20 controls the blower 12 such that the volume of air sent by the blower 12 is larger than when the seat angle α is smaller than the angle threshold α1. This can prevent a decrease in the blown air volume from the foot outlet 30a due to the increase in the face air volume ratio in step S104 of FIG. 13.

The occupant 76 may recline the seat back 742 and lie down in a vehicle performing automated driving or in a following vehicle in a platoon, for example, where the control processing in FIG. 13 is particularly effective for such vehicle performing automated driving or following vehicle in the platoon.

### Other Embodiments

(1) The first embodiment described above illustrates one example that, as illustrated in FIG. 5, the positive direction of the seat angle α of the driver's seat 74 corresponds to the direction in which the seat back 742 is reclined to cause the backrest surface 742a to face upward. Conversely, for example, the negative direction of the seat angle α may correspond to the direction in which the seat back 742 is reclined to cause the backrest surface 742a to face upward. Basically, the maps MPd and MPv in FIGS. 8 and 9 need only be provided appropriately according to the positive direction and the negative direction of the seat angle α.

(2) The first embodiment described above illustrates one example that, as illustrated in FIG. 5, the positive direction of the seat position L of the driver's seat 74 corresponds to the rear of the vehicle. Conversely, for example, the negative direction of the seat position L may correspond to the rear of the vehicle. Basically, the maps MPd and MPv in FIGS. 8 and 9 need only be provided appropriately according to the positive direction and the negative direction of the seat position L.

(3) The first embodiment described above illustrates one example that, as illustrated in FIG. 1, the outlet 14a blows the air toward the target seat which is the driver's seat 74. The target seat may be a seat other than the driver's seat 74 such as a passenger seat, for example. Even in that case, the blown air volume V and the blowing direction β from the outlet 14a are controlled depending on the seat angle α and the seat position L of the target seat.

(4) In the first embodiment described above, as illustrated in FIGS. 1 and 3, the air direction adjustment device 16 includes the air direction adjustment fins 161 and adjusts the blowing direction β of the blown air Ar by the orientation of the air direction adjustment fins 161. However, a configuration in which the air direction adjustment device 16 includes no air direction adjustment fin 161 can also be conceived. For example, the air direction adjustment device 16 may be configured by a mechanism that changes the orientation of the outlet 14a by turning the outlet portion 14 itself in which the outlet 14a is formed. Alternatively, the air direction adjustment device 16 may be configured by a mechanism that adjusts the blowing direction β using the Coanda effect.

(5) In the first embodiment described above, as illustrated in FIG. 1, the air volume adjustment device for increasing or decreasing the blown air volume V of the air Ar blown out from the outlet 14a is specifically the blower 12, but the air volume adjustment device may be a device other than the blower 12. For example, when an opening/closing device for opening/closing another outlet other than the outlet 14a as the face outlet is provided, the opening/closing device may function as the air volume adjustment device. In that case, the opening/closing device decreases the blown air volume V from the outlet 14a by increasing the opening of the other outlet, for example.

(6) In each embodiment described above, the vehicle air conditioning unit 10 includes the control unit 20, but the control unit 20 need not be a physically independent control device. For example, the control unit 20 may be provided as one functional unit included in a certain control device.

(7) In the second embodiment described above, the face door 32 and the foot door 34 illustrated in FIG. 12 form the air volume ratio change unit for changing the face air volume ratio, but the air volume ratio change unit need not be formed by a door mechanism. The place of installation of each of the face door 32 and the foot door 34 is not limited as long as the doors 32 and 34 function as the air volume ratio change unit.

(8) In the second embodiment described above, the control processing of FIG. 13 is executed in parallel with the control processing of FIG. 6 and the control processing of FIG. 7, but need not necessarily be executed in parallel therewith. That is, the control unit 20 may execute the control processing of FIG. 13 without executing the control processing of FIG. 6 and the control processing of FIG. 7.

(9) In the second embodiment described above, the flowchart of FIG. 13 includes steps S105 and S108 but need not necessarily include steps S105 and S108. That is, the flowchart of FIG. 13 not including steps S105 and S108 is possible.

(10) In each embodiment described above, the processing of each step illustrated in the flowcharts of FIGS. 6, 7, and 13 is implemented by a computer program but may be configured by hard logic.

(11) The present disclosure is not limited to the embodiments described above but can be implemented while being modified in various ways. In the above embodiments, it is needless to say that the elements included in the embodiments are not necessarily essential unless specified to be essential or considered to be clearly essential in principle.

The numerical values such as the number, numerical value, amount, range, and the like of the elements of the embodiments mentioned in the above embodiments are not limited to specific numbers unless specified that the specific numbers are essential or clearly limited to the specific numbers in principle. Moreover, the materials, shapes, positional relationships, and the like of the elements and the like mentioned in the above embodiments are not limited to the materials, shapes, positional relationships, and the like unless otherwise specified or limited to specific materials, shapes, positional relationships, and the like in principle.

### (Overview)

According to a first aspect shown in a part or whole of the above-described embodiments, the control unit of the vehicle air conditioning unit controls the air volume adjustment device to increase the blown air volume with reclination of the seat back causing a backrest surface of the seat back to face upward.

According to a second aspect, the control unit controls the air direction adjustment device to change the blowing direction downward with reclination of the seat back causing the backrest surface of the seat back to face upward. As a result, when the posture of the occupant seated in the target seat changes, change of area of the body of the occupant on which the blown air is blown from the outlet can be limited. Therefore, comfortable air conditioning can be provided appropriately to the posture of the occupant. A third aspect is similar to the second aspect.

According to a fourth aspect, a direction in which the seat back is reclined to cause the backrest surface of the seat back to face upward is defined as a direction that a reclination angle of the seat back is positive and increases. In this case, when the reclination angle is larger than or equal to a predetermined angle threshold in a blow mode in which the air is blown into the vehicle compartment from the first outlet and the second outlet, the control unit controls the air volume ratio change unit to set the first outlet air volume ratio to be larger than that when the reclination angle is smaller than the angle threshold. As a result, when the seat back of the target seat in which the occupant is seated is reclined to allow the occupant to be in a lying posture, for example, an occupant's feeling of decrease in the volume of air blown on his upper body can be reduced. Therefore, comfortable air conditioning can be provided appropriately to the posture of the occupant.

According to a fifth aspect, when the reclination angle is larger than or equal to the angle threshold in the blow mode in which the air is blown into the vehicle compartment from the first outlet and the second outlet, the control unit controls the blower to set the total air volume to be larger than that when the reclination angle is smaller than the angle threshold. This can prevent a decrease in the blown air volume from the second outlet due to the increase in the first outlet air volume ratio.

According to a sixth aspect, a direction in which the seat back is reclined to cause the backrest surface of the seat back to face upward is defined as a direction that the reclination angle of the seat back is positive and increases. In this case, when the reclination angle is larger than or equal to a predetermined angle threshold in a blow mode in which the air is blown into the vehicle compartment from the first outlet and the second outlet, the control unit controls the air volume ratio change unit to set the first outlet air volume ratio to be larger than that when the reclination angle is smaller than the angle threshold. Therefore, as with the fourth aspect, comfortable air conditioning can be provided appropriately to the posture of the occupant.

According to a seventh aspect, a direction in which the seat back is reclined to cause a backrest surface of the seat back to face upward is defined as a direction that a reclination angle of the seat back is positive and increases. In this case, when the reclination angle is larger than or equal to a predetermined angle threshold in a blow mode in which the air is blown into the vehicle compartment from the first outlet and the second outlet, the control unit controls the air volume ratio change unit to set the first outlet air volume ratio to be larger than that when the reclination angle is smaller than the angle threshold.

According to an eighth aspect, when the reclination angle is larger than or equal to the angle threshold in the blow mode in which the air is blown into the vehicle compartment from the first outlet and the second outlet, the control unit controls the blower to set the total air volume to be larger than that when the reclination angle is smaller than the angle threshold. Therefore, as with the fifth aspect, a decrease in the blown air volume from the second outlet due to the increase in the first outlet air volume ratio can be prevented.

What is claimed is:

1. A vehicle air conditioning unit installed in a vehicle including a target seat placed in a vehicle compartment, the target seat having a seat back operable to be reclined, the vehicle air conditioning unit comprising:
an outlet portion having an outlet which is open in front of the target seat and through which air is blown toward the target seat in the vehicle compartment;
a blower configured to increase or decrease a blown air volume of the air blown out from the outlet; and
a controller configured to control the blower to increase the blown air volume with reclination of the seat back causing a backrest surface of the seat back to face upward.

2. The vehicle air conditioning unit according to claim 1, further comprising a fin configured to angularly adjust a blowing direction of the air blown out from the outlet upward or downward, wherein
the controller controls the fin to change the blowing direction downward with reclination of the seat back causing the backrest surface of the seat back to face upward.

3. The vehicle air conditioning unit according to claim 1, comprising:
a first outlet portion as the outlet portion;
a second outlet portion having a second outlet through which air is blown to a lower area in the vehicle compartment than a first outlet as the outlet; and
a door configured to change a first outlet air volume ratio which is a ratio of the blown air volume from the first outlet to a total air volume of the airs blown out from the first outlet and the second outlet, wherein
the first outlet is an outlet through which the air is blown toward an upper body of an occupant seated in the target seat, and
when a direction in which the seat back is reclined to cause the backrest surface of the seat back to face upward is defined as a direction that a reclination angle of the seat back is positive and increases, and the reclination angle is larger than or equal to a predetermined angle threshold in a blow mode in which the air is blown into the vehicle compartment from the first outlet and the second outlet, the controller controls the door to set the first outlet air volume ratio to be larger than that when the reclination angle is smaller than the angle threshold.

4. The vehicle air conditioning unit according to claim 3, wherein
the blower sends air to the first outlet and the second outlet, and
when the direction in which the seat back is reclined to cause the backrest surface to face upward is defined as the direction that the reclination angle of the seat back is positive and increases, and the reclination angle is larger than or equal to the angle threshold in the blow mode in which the air is blown into the vehicle compartment from the first outlet and the second outlet, the controller controls the blower to set the total air volume to be larger than that when the reclination angle is smaller than the angle threshold.

5. The vehicle air conditioning unit according to claim 1, wherein
the target seat is disposed to be slidable, and
the controller controls the blower to increase the blown air volume with increase in distance from the target seat to the outlet.

6. A vehicle air conditioning unit installed in a vehicle including a target seat placed in a vehicle compartment, the target seat having a seat back operable to be reclined, the vehicle air conditioning unit comprising:
a first outlet portion having a first outlet which is open in front of the target seat and through which air is blown toward the target seat in the vehicle compartment;
a second outlet portion having a second outlet through which air is blown to a lower area in the vehicle compartment than the first outlet;
a fin configured to angularly adjust a blowing direction of the air blown out from the outlet upward or downward;
a door configured to change a first outlet air volume ratio which is a ratio of a blown air volume of the air blown out from the first outlet to a total air volume of the airs blown out from the first outlet and the second outlet; and
a controller configured to control the fin to change the blowing direction downward with reclination of the seat back causing a backrest surface of the seat back to face upward, wherein
the first outlet is an outlet through which the air is blown toward an upper body of an occupant seated in the target seat, and
when a direction in which the seat back is reclined to cause the backrest surface of the seat back to face upward is defined as a direction that the reclination angle of the seat back is positive and increases, and the reclination angle is larger than or equal to a predetermined angle threshold in a blow mode in which the air is blown into the vehicle compartment from the first outlet and the second outlet, the controller controls the door to set the first outlet air volume ratio to be larger than that when the reclination angle is smaller than the angle threshold.

7. A vehicle air conditioning unit installed in a vehicle including a target seat placed in a vehicle compartment, the target seat having a seat back operable to be reclined, the vehicle air conditioning unit comprising:
a first outlet portion having a first outlet through which air is blown toward an upper body of an occupant seated in the target seat;
a second outlet portion having a second outlet through which air is blown to a lower area in the vehicle compartment than the first outlet;
a door configured to change a first outlet air volume ratio which is a ratio of a blown air volume of the air blown out from the first outlet to a total air volume of the airs blown out from the first outlet and the second outlet; and
a controller, wherein
when a direction in which the seat back is reclined to cause a backrest surface of the seat back to face upward is defined as a direction that a reclination angle of the seat back is positive and increases, and the reclination angle is larger than or equal to a predetermined angle threshold in a blow mode in which the air is blown into the vehicle compartment from the first outlet and the second outlet, the controller controls the door to set the first outlet air volume ratio to be larger than that when the reclination angle is smaller than the angle threshold.

8. The vehicle air conditioning unit according to claim 6, further comprising a blower that sends air to the first outlet and the second outlet, wherein
when the direction in which the seat back is reclined to cause the backrest surface to face upward is defined as a direction that the reclination angle is positive and increases, and the reclination angle is larger than or equal to the angle threshold in the blow mode in which the air is blown into the vehicle compartment from the first outlet and the second outlet, the controller controls the blower to set the total air volume to be larger than that when the reclination angle is smaller than the angle threshold.

9. A vehicle air conditioning unit installed in a vehicle including a target seat placed and slidable in a vehicle compartment, the vehicle air conditioning unit comprising:
an outlet portion having an outlet which is open in front of the target seat and through which air is blown toward the target seat in the vehicle compartment;
a blower configured to increase or decrease a blown air volume of the air blown out from the outlet; and
a controller configured to control the air volume adjustment device to increase the blown air volume with increase in distance from the target seat to the outlet.
